(19) United States
(12) Patent Application Publication
(10) Pub. No.: US 2024/0011215 A1
(43) Pub. Date: Jan. 11, 2024

(54) WASHING MACHINE AND METHOD FOR OPERATING A WASHING MACHINE

(71) Applicant: E.G.O. Elektro-Geraetebau GmbH, Oberderdingen (DE)

(72) Inventors: Antonio Di Maggio, Schwaigern (DE); Uwe Schaumann, Oberderdingen (DE)

(21) Appl. No.: 18/341,872

(22) Filed: Jun. 27, 2023

(30) Foreign Application Priority Data
Jul. 5, 2022 (DE) 10 2022 206 864.5

(51) Int. Cl. D06F 39/08; D06F 23/02; D06F 39/10; D06F 33/42; D06F 33/34; D06F 34/22; D06F 39/02; D06F 39/04; D06F 33/43; B01D 29/66

(52) U.S. Cl. CPC D06F 39/085; D06F 23/02; D06F 39/088; D06F 39/10; D06F 33/42; D06F 33/34; D06F 34/22; D06F 39/02; D06F 39/04; D06F 33/43; B01D 29/66; D06F 2105/08

(57) ABSTRACT

A washing machine has a drum-receiving container and a rotatable drum therein and a water routing system which has a water inlet from an external water supply into the washing machine, water lines and valves, as well as a water outlet from the washing machine. An injection device for water into the drum, a container outlet at the bottom of the drum-receiving container, a pump, a filter and a washing machine controller are provided. The water routing system drive has an adjustable pressure-reducing device arranged between, on the one hand, the water inlet into the washing machine and, on the other hand, the pump and/or the injection device. The pressure-reducing device is connected, for adjustment, to the washing machine controller.

### CROSS-REFERENCE TO RELATED APPLICATIONS

This application claims priority to German Application No. 10 2022 206 864.5, filed Jul. 5, 2022, the contents of which are hereby incorporated herein in its entirety by reference.

### FIELD OF APPLICATION AND PRIOR ART

The invention relates to a washing machine and to a method for operating such a washing machine.

US 2005/0000031 A1 discloses a washing machine with what is known as a recirculation system, in which water is introduced not from the outside into a drum arranged in a drum-receiving container by partially flooding the drum receiving container, but instead directly into the drum through an axis of rotation. A lower water level can thus be provided in the lower region of the drum-receiving container. This can reduce the formation of suds.

EP 726349 A2 discloses a washing machine with just one pump. This results in a problem for reliable operation of the pump, since air or suds in the washing machine make robust operation more difficult, and discontinuous operation is thus only possible to a limited extent.

### OBJECT AND ACHIEVEMENT THEREOF

The object of the present invention is to provide a washing machine as stated above and a method for the operation thereof as stated above, with which prior art problems can be solved and which make it in particular possible to efficiently operate a washing machine and preferably to ensure, for example, venting during operation of the washing machine with only one pump, such that no special pump construction is necessary.

Said object is achieved by a method having the features of claim 1 and by a washing machine having the features of claim 17. Advantageous and preferred embodiments of the invention are the subject matter of further claims and are explained in greater detail in the following. Some of the features are described only for the washing machine or for the method. They are, however, intended to apply by themselves and independently of one another both to such a washing machine and to such a method. The wording of the claims is incorporated by express reference into the content of the description.

The washing machine has a drum for washing laundry therein and a drum-receiving container in which the drum is rotatably arranged. It also has a water routing system which in turn has a water inlet from an external water supply into the washing machine, water lines and valves, a water outlet from the washing machine, an injection device for water into the drum and a container outlet at the bottom of the drum-receiving container. The washing machine furthermore has a pump connected by way of water lines, on the one hand, to the container outlet and, on the other hand, to the injection device, as well as a filter for filtering water flowing through it. It also has a washing machine controller which is connected to the pump and possibly also a drive motor together with an inverter for controlling the drive motor.

According to the invention, the water routing system has an adjustable pressure-reducing device arranged between, on the one hand, the water inlet into the washing machine and, on the other hand, the pump and/or the injection device. The pressure-reducing device is connected for the adjustment or setting thereof to the washing machine controller and receives commands therefrom and can also report its status back thereto. Pressure-reducing devices on a washing machine are known and serve to limit the water pressure of water flowing into the washing machine. In this way, the washing machine and in particular its water routing system and optionally also a pump can be protected from excessive water pressure. Limitation is provided to a fixed value which is usually permanently set to between 2 bar and 3 bar. This is sufficient for admitting water into the washing machine with sufficient pressure and a sufficient flow rate.

The invention makes it possible to set the water pressure of water flowing into the washing machine so that it can be adapted to possible phases in the course of a washing process. If water is only to be admitted into the washing machine, a relatively low pressure is sufficient, for example the above-stated 2 bar to 3 bar. If the water pressure is set higher, advantageously 5 bar to 8 bar, if permitted by the external water supply, it can also be used to perform a function such as rinsing, cleaning or backflushing the filter in the water routing system. It is then not necessary to use the pump for this purpose, or a pump may be of simpler construction, such that it need not necessarily be able to generate such high water pressures. This simplifies the design of the water routing system and in particular of the pump and, in addition, energy can optionally be saved.

The pressure-reducing device can advantageously be arranged between the water inlet into the washing machine and further regions of the water routing system, in particular upstream of the filter and upstream of the pump. Water admitted at relatively high pressure can accordingly be both generally filtered and used for backflushing or cleaning the filter. The water inlet can be routed to the filter, in particular directly, wherein preferably just one water line which is valve-free or has no valve therein is arranged between the pressure-reducing device and the filter. A valve may be arranged upstream of the adjustable pressure-reducing device, in particular in order to admit the desired volume of water. A pressure sensor may also be provided, advantageously upstream and/or downstream of the pressure-reducing device. In this way, the washing machine controller can obtain information regarding the maximum possible water pressure and the set water pressure. A pressure sensor can possibly be integrated into the pressure-reducing device.

In one advantageous development of the invention, a nonreturn valve may be present in the pressure-reducing device. This nonreturn valve, does not allow the fluid or gas flowing through it to flow back in the opposite direction in addition to throttling it in the direction of water flow. As a result, pressure is reduced and at the same time backflow into the water inlet or into the water supply is prevented.

The pressure-reducing device can have a fixed setting or be adjustable.

It is possible for the water routing system itself to have at least one pressure sensor which may preferably be arranged in the drum-receiving container. It may here be arranged in the lower region of the drum-receiving container at or close to the container outlet.

The filter can be arranged in a water line between the container outlet and the pump. In this way, foreign bodies or impurities escaping from the laundry which should be filtered out of the water can be filtered out upstream of the pump. This serves to protect the pump.

The filter can advantageously have a filter inlet, a filter outlet and a backflush inlet. The pressure-reducing device can be connected directly to the backflush inlet by way of a water line without a valve, such that it is possible for it to backflush the filter to clean it. Especially at this point, this can cause the pressure-reducing device to set the pressure very high and at its maximum for backflushing the filter, such that the filter can be backflushed and cleaned using a maximally high water pressure. In this case, a washing machine pump is not additionally needed, it is possible to use solely the high water pressure possibly present at the water inlet due to a supply line in the building. This is gentle on the pump and saves energy. Furthermore, the pump can in this way possibly be of simpler construction as it does not have to be able to deliver the high pressures required for backflushing a filter.

In a further development of the invention, a valve can be arranged between the container outlet and the filter or filter inlet, in particular the valve may be a two-way valve. In this way, the filter can, as it were, be closed. Alternatively, this valve can also be arranged directly at the container outlet.

In another further development of the invention, a valve can be arranged downstream of the filter outlet and in particular in a water line from the filter outlet to the pump, which valve may in particular be a first three-way valve. It is possible for one connection of this first three-way valve to be routed to the injection device by way of water lines, wherein another connection can be routed to the above-stated pump.

It may preferably also be provided that a further, second three-way valve be arranged downstream of the connection of the first three-way valve to the injection device. It is possible for one connection of this further, second three-way valve to be routed to the injection device or to be connected thereto. The other connection of this further, second three-way valve may advantageously be routed to the pump.

A further, third three-way valve may particularly preferably be arranged downstream of the other connection of the second three-way valve to the injection device, wherein one of its connections is routed to the water outlet from the washing machine. Its other connection can be routed to the injection device.

In a further development of the invention, the washing machine may have a flow sensor, in particular in the water routing system. Such a flow sensor can advantageously be arranged at the water inlet into the washing machine, particularly advantageously where the water inlet enters the housing of the washing machine. The distance from a water connection on the outside of the housing, in particular in the form of a quick connection or screw connection, or alternatively from an outer wall of the housing, may be less than 15 cm, advantageously less than 5 cm. In this way, it is possible to detect exactly how much water has been admitted into the washing machine. The volume of water in the washing machine is thus also known.

The washing machine may have a dispensing device for apportioning laundry detergents or other substances, generally substances providing washing action, for laundry treatment in the washing machine. This dispensing device may be arranged in the water line upstream of the pump, in particular between the filter and the pump. It may be at a distance of less than 30 cm or less than 20 cm from the pump.

The washing machine may advantageously have a heating means for water in the water routing system, wherein the heating means is either separate from the pump and in particular arranged at a distance of between 5 cm and 30 cm from the pump or is combined with or integrated into the pump. In this connection, reference is made for example to US 2013/022455 A1. A separate heating means may be arranged upstream of the pump or also downstream of the pump.

The pressure-reducing device can advantageously be arranged in an independently handleable module within the lower region of the washing machine which is configured to be movable as a module. Such a module may, for example, take the form of a kind of drawer, in which a plurality of functional units of the washing machine, inter alia the pressure-reducing device and in particular also water lines, a pump, a valve and preferably a filter, are arranged as a kind of functional module. These are thus substantially the complex water-conveying functional units of the washing machine. The water lines may be at least partially variable in length. This is advantageously in accordance with EP 4086383 A1, the content of which is in this respect incorporated by express reference into the content of the present application.

In a method according to the invention for operating a washing machine according to the invention, as has been described above, a defined water pressure is set at the beginning of the operation thereof by way of the pressure-reducing device. This defined water pressure may be between 1.5 bar and 4 bar, in particular between 1.8 bar and 2.5 bar. Thus, in accordance with a program preset for operation, water can be fed at this water pressure into the washing machine from the external water supply via a water inlet. In a further method step, the filter can be backflushed, for which purpose a water pressure of at least 5 bar, preferably 7 bar up to a maximum pressure of an external connecting line or supply line in the building, can be set by way of the pressure-reducing device. In this way, the filter can be backflushed and thus cleaned efficiently and at high water pressure in the above-stated manner very simply and without costly use of a pump.

In one development of the invention, for backflushing the filter, the water pressure can be varied by at least 50%, preferably varied by at least 50% every 0.5 sec to 10 sec. The water pressure can in particular be varied in abrupt or pulsed manner. As a result, it is particularly readily possible to detach particles or impurities which are present in the filter, in particular those which have been filtered out and have become stuck, and to rinse them out during backflushing.

In a further method step for a washing process with repeated introduction of water into the drum by way of the injection device, a water pressure of between 2 bar and 3 bar is set by way of the pressure-reducing device. This may be an advantageous water pressure for operation of the washing machine when a very high or maximally high water pressure is not desired, for example, for backflushing the filter.

In one development of the invention, the water pressure while the drum is being filled with water can be increased by way of the adjustable pressure-reducing device in the event that the drum has previously been emptied by way of the pump. The water pressure may here preferably be increased up to a maximum pressure of a connecting line to the water inlet.

In a further development of the invention, when the pump is empty and prior to starting operation of the pump, water may be admitted into the pump or the pump chamber thereof at a water pressure which is above the usual water pressure for a washing process. For this purpose, a water pressure of at least 5 bar may advantageously be set by way of the adjustable pressure-reducing device. To this end, the water pressure in the water routing system or of the water admitted into the washing machine at the water inlet may not be reduced or decreased by way of the pressure-reducing device, the pressure-reducing device thus being, as it were, fully open.

In one advantageous development of the invention, the following steps may be carried out in the method. Within at most 5 sec of, preferably simultaneously with, setting the water pressure, a valve at the water inlet can be opened. A valve between the filter and the container outlet is opened or is already open, while a valve between the filter and the pump is closed or is in a closed state. The filter is then vented into the drum-receiving container or vented through the container outlet, wherein it may here be provided that there is no water flow through the pump at this point. The valve between the filter and the pump is then opened and thereafter the pump is vented through opened valves and water lines into the drum or into the drum-receiving container and filled with water through the filter. Water can here be recirculated by the pump in a circuit through the pump without the water reaching the drum-receiving container or the drum. This can advantageously be done in such a manner that the water does not reach the filter, wherein the water is here heated by way of a heating means past which the water flows. Once a desired temperature has been reached, the heated water can then be introduced into the drum or into the drum-receiving container through opened valves and water lines.

For emptying the washing machine, provision may be made for a valve between the container outlet and filter to be closed, wherein fresh water is introduced into the drum or into the drum-receiving container via a water line and a valve in order to rinse the drum. A valve downstream of the pump can then be closed, such that a water line from this valve to a further valve, which is arranged between the filter and pump, is open and is rinsed. Once this water line has been rinsed, the valve downstream of the pump may here be set such that the water which has been used for rinsing can be pumped out of the drum by the pump via a water line and a further valve to the water outlet out of the washing machine.

These and further features are revealed in the description and in the drawings as well as in the claims, wherein the individual features can each be realized singly or severally in the form of sub-combinations in one embodiment of the invention and in other fields, and can represent embodiments advantageous and protectable per se, for which protection is claimed here. The subdivision of the application into individual sections and sub-headings does not limit the statements made thereunder in terms of their general applicability.

### BRIEF DESCRIPTION OF THE DRAWINGS

Further advantages and aspects of the invention are revealed by the claims and the description of exemplary embodiments of the invention, which are explained below with reference to the FIGURE.

FIG. 1 is a diagram of a washing machine with an internal structure and a water routing system with lines as well as a pressure reducer.

### DETAILED DESCRIPTION OF THE EXEMPLARY EMBODIMENTS

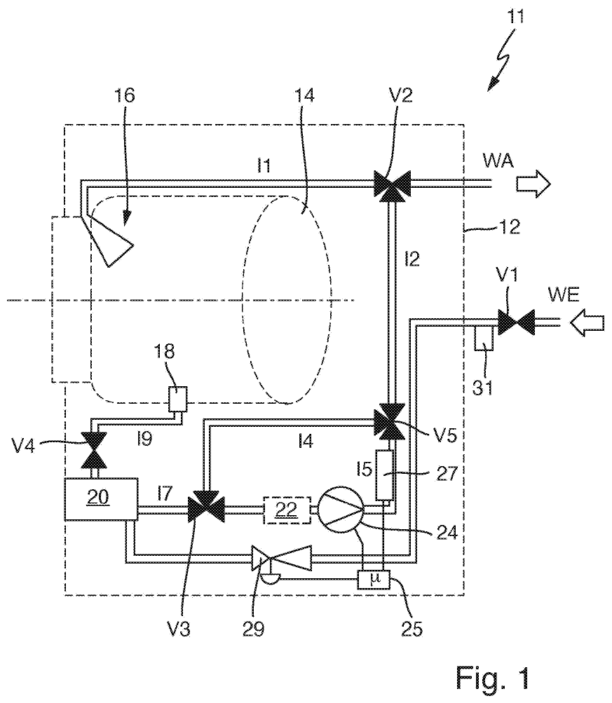

FIG. 1 shows a washing machine 11 with a housing 12 in which is arranged a drum-receiving container 14 with a drum (not shown) in which laundry is washed. At the bottom of the drum-receiving container 14 with a container outlet to a water line l9 there is a valve V4, downstream of which there is a filter 20. Upstream of the filter 20, a water line l7 goes to a three-way valve V3, one of the outlets of which goes to a dispensing means 22 and then to a pump 24. The outlet of the latter is provided with a heater 27 by way of a water line l5 and leads to a further three-way valve V5, one of the outlets of which goes by way of a water line 14 back to the three-way valve V3. In this way, a circuit as described above can be formed, in which the pump 24 can circulate water in the circuit or loop, preferably in order to slowly heat it to a desired temperature by way of the heater 27.

Upstream of the valve V5, a water line l2 goes to a three-way valve V2, the right-hand outlet of which forms a water outlet WA from the washing machine 11. Its left-hand outlet leads by way of a water line l1 to an injection device 16 for water into the drum-receiving container 14 or into the drum.

A water inlet into the washing machine 11 is provided by an external connecting line, advantageously as a flexible hose, from a supply line in the building, as is known from the prior art. A screw connection, frequently with a water-stop device, is conventionally provided at the water inlet. A flow sensor 31 is here provided, with which it can be detected how much water has been admitted from the valve V1 at the water inlet WE into the washing machine 11 or into its water routing system. A water line l6 leads to the filter 20 or to a backflush inlet of the filter 20. In this way, a maximally high water pressure for backflushing can be applied directly to the filter 20. An adjustable pressure reducer 29 according to the invention is arranged in this water line l6. The pressure reducer 29 is controlled by a controller 25 which is connected to all the influenceable or controllable functional units of the washing machine 11; a connection to the pump 24 and to the heater 27 is shown here. Advantageously, the controller 25 is also connected to the valves, the pressure sensor 18, the dispensing means 22 and the flow sensor 31 for the control thereof.

The pressure reducer 29 is set as previously explained, for example a pressure of 2 bar for the normal washing process. This enables protection of the appliance and a defined pressure in the washing machine 11 irrespective of a water pressure predetermined in the building. The operation or adjustment thereof, in particular setting or allowing the passage of a maximally high water pressure, advantageously for backflushing the filter 20, proceeds as previously described. This is readily conceivable on the basis of FIG. 1. Impurities rinsed out during backflushing can be removed from the washing machine 11 via valve V3, water line l4, valve V5 together with water line l2 and valve V2 to water outlet WA.

On starting operation of the washing machine 11, the valve V1 is opened and a defined pressure, for example 2 bar, set via the pressure reducer. In this way, the washing machine 11 can be protected and a defined pressure prevails in the system irrespective of the building installation. The pressure reducer 29 can be controlled by the controller 25.

Valve V4 is open to ensure venting on start-up. Valve V3 is closed in the direction of pump 24. Line 19 permits venting of filter 20 and line l9 via the drum-receiving container 14. The water rises up to the inlet of line l9 on the drum-receiving container 14.

During subsequent start-up, the pump 24 is filled with water through line l7, once valves V3, V5 and V2 are open. Air can be forced via line l5 into the drum-receiving container 14. Due to the volume in filter 20 and in l9, sufficient water is present to fill or flood pump 24 and lines 14 and 15. V3 and V5 are then set such that a circuit around pump 24 with lines 15 and 14 and through valves V3 and V5 is obtained. Pump 24 can be switched on and the water begins to circulate. The heater 27 can here be switched on without danger since “dry running” with the risk of excessive heating is no longer possible.

Once the desired temperature has been reached, valve V5 can be opened and water routed into the drum-receiving container 14. In this way, a defined volume at an appropriate temperature can be introduced via the injection device 16 into the drum or into the drum-receiving container 14. The described process can be performed repeatedly until the laundry in the drum is wetted or drenched to a desired extent.

Depending on the volume of laundry loaded into drum, the process is performed repeatedly until it can be ensured that backflow from the drum-receiving container 14 is possible because water absorption by the laundry has reached saturation. This can be detected by way of sensors or by way of empirical values. Operation can be changed over to continuous recirculation. A desired temperature in the drum or on the laundry can be set since the manner in which the washing machine is constructed as well as the ambient temperature etc. are known, such that temperature control in the circuit can be adjusted by the pump 24 and lines 15 and 14 in accordance with the particular cycle.

Instead of discontinuous operation, continuous operation can also be used for wetting the laundry. Valve V1 is accordingly opened such that water can continue to flow until the laundry is wetted and backflow from the drum is identified or the calculated water volume (based on load volume, type of textile, etc.) is reached. Precise temperature control on the laundry as in discontinuous operation is conceivable, but significantly more difficult to control. V4 is closed in this case so that no water reaches the drum-receiving container 14 via the filter 20. When valve V1 is opened, a defined pressure, for example 2 bar, can be set via pressure reducer 29, such that the volume is known as determined by the calculation.

At the beginning of washing, valve V1 at water inlet WE is left open for as long as is necessary, based on the structural embodiment, to allow the appropriate volume of water to be provided. Operation may here be discontinuous or continuous as previously described. Since the laundry is located in the drum, it absorbs water until the pressure sensor 18 which is located on the drum-receiving container 14 responds. Alternatively, the necessary volume can be determined via the measured volume of water and the weight of the laundry. Depending on the type of textile, account must be taken of a different absorption capacity, which is why the pressure sensor for can also be used for corresponding switching off.

In the described embodiment, the laundry can also be drenched from below, which in essence corresponds to current washing processes (scoop-and-ladle rib system), where the water flows into the tub and thus the drum from above via the detergent drawer. Since the filter can easily be cleaned after each washing process, the laundry is not soiled.

If the recirculation method is preferred in order to provide as little water as possible, the drum rotates and the water is applied to the laundry in the drum via the injection device 16. In order to prevent switching off here and thus an excessive volume of water in the process, water reflux can likewise be identified via the pressure sensor 18 or, for optimization, via an additional turbidity sensor in line l7 (not shown in FIG. 1). The function of the turbidity sensor is to monitor the filter 20. The change from air to water can additionally be identified with a turbidity sensor. Alternatively, a conductivity measurement can be provided in parallel which, in addition to process parameters, can also identify water backflow. Water backflow can also be identified via temperature monitoring.

A further solution is to use a pump which is controlled by an inverter and can identify air in the pump via its current characteristic. This solution is, however, not possible for simple pumps. As soon as a sufficient volume is available for the washing process, the washing process can be continued with the appropriate dispensing.

If water is pumped out during the washing process, this is achieved via valve V2. Lines 17 and 15 are not completely emptied here, since a time limitation is possible via feedback from the pressure sensor 18 and, optionally, the turbidity sensor. Given appropriate feedback from the two sensors, fresh water can be continuously supplied until a stable state is obtained. Filling with fresh water after intermediate spinning is possible in a similar manner to start-up. The position of valve V4 is the same here.

The washing machine 11 can be emptied at the end of the washing process via pump 24 as complete emptying of the system, so enabling a reduction in microbial contamination therein. If cleaning is also to be carried out, this can be done once the washing machine 11 has been emptied. Valve V4 is closed such that the drum is isolated from the water routing system. Via V2, fresh water for rinsing, possibly preceded by cleaning agent, can be introduced via the dispensing means 22. V5 is here closed such that line l4 is open. Once line l4 has been rinsed, V5 is set such that line l2 conveys the water out via V2. The pump 24 is here continuously rinsed. In addition to being flushed, the filter 20 and pump 24 can also be flooded with water and appropriate cleaning agents for a certain exposure time, which improves the cleaning action.

1. A washing machine having:
a drum for washing laundry therein,
a drum-receiving container with said drum being rotatably arranged therein,
a water routing system having:
a water inlet from an external water supply into said washing machine,
water lines and valves,
a water outlet from said washing machine,
an injection device for water into said drum,
a container outlet at a bottom of said drum-receiving container,
a pump being connected by way of water lines, on the one hand, to said container outlet and, on the other hand, to said injection device,
a filter for filtering water flowing through said filter,
a washing machine controller, wherein said pump is connected to said washing machine controller,
wherein:
said water routing system has an adjustable pressure-reducing device,
said pressure-reducing device is arranged between, on the one hand, said water inlet into said washing machine and, on the other hand, said pump or said injection device,
said pressure-reducing device is connected, for adjustment, to said washing machine controller.

2. The washing machine as claimed in claim 1, wherein said pressure-reducing device is arranged between said water inlet into said washing machine and further regions of said water routing system and upstream of said filter and upstream of said pump.

3. The washing machine as claimed in claim 2, wherein said water inlet is routed to said filter and only one of said water lines is arranged between said pressure-reducing device and said filter, wherein said water line is without any valve.

4. The washing machine as claimed in claim 1, wherein said water routing system has at least one pressure sensor in said drum-receiving container in a lower region of said drum-receiving container at or close to said container outlet.

5. The washing machine as claimed in claim 1, wherein said water routing system has a flow sensor at said water inlet into said washing machine.

6. The washing machine as claimed in claim 1, wherein said filter is arranged in one said water line between said container outlet and said pump.

7. The washing machine as claimed in claim 1, wherein said filter has a filter inlet, a filter outlet and a backflush inlet, wherein said pressure-reducing device is directly connected to said backflush inlet by way of one of said water lines without any valve.

8. The washing machine as claimed in claim 7, wherein a valve is arranged between said container outlet and said filter or said filter inlet.

9. The washing machine as claimed in claim 7, wherein a first three-way valve is arranged downstream of said filter outlet and in one of said water lines from said filter outlet to said pump, wherein one connection of said first three-way valve is routed to said injection device by way of said water lines.

10. The washing machine as claimed in claim 9, wherein a further, second three-way valve is arranged downstream of said connection of said first three-way valve to said injection device, wherein one connection of said second three-way valve is routed to said injection device and another connection of said second three-way valve is routed to said pump.

11. The washing machine as claimed in claim 10, wherein a further, third three-way valve is arranged downstream of said other connection of said second three-way valve to said injection device, wherein one connection of said third three-way valve is routed to said water outlet from said washing machine and another connection of said third three-way valve is routed to said injection device.

12. The washing machine as claimed in claim 1, wherein said washing machine has a dispensing device for apportioning laundry detergents or other substances for laundry treatment in said washing machine, wherein said dispensing device is arranged in said water line upstream of said pump.

13. The washing machine as claimed in claim 12, wherein the dispensing device is arranged in said water line between said filter and said pump at a distance of less than cm from said pump.

14. The washing machine as claimed in claim 1, wherein said washing machine has a heating means for said water in said water routing system, wherein said heating means is separate from said pump and arranged at a distance of between 5 cm and 30 cm from said pump.

15. The washing machine as claimed in claim 1, wherein said pressure-reducing device is arranged in an independently handleable module within a lower region of said washing machine and is configured to be movable as a movable module.

16. The washing machine as claimed in claim 15, wherein water lines, a pump, a valve and a filter are arranged in said movable module.

17. A method for operating said washing machine as claimed in claim 1, wherein
a defined water pressure, which is between 1.5 bar and 4 bar, is set at a beginning of an operation of said washing machine by way of said pressure-reducing device in order, in accordance with a preset program, to feed water at said water pressure into said washing machine from said external water supply,
in a further method step, said filter is backflushed, for which purpose a water pressure of at least 5 bar is set by way of said pressure-reducing device,
in a further method step for a washing process with repeated introduction of water into said drum by way of said injection device, a water pressure of between 2 bar and 3 bar is set by way of said pressure-reducing device.

18. The method as claimed in claim 17, wherein, for backflushing said filter, said water pressure is varied by at least 50%.

19. The method as claimed in claim 18, wherein said water pressure is varied by at least 50% at least every 0.5 sec to 10 sec in such manner that said water pressure is varied in abrupt or pulsed manner.

20. The method as claimed in claim 17, wherein, in an event that said drum has previously been emptied by way of said pump, said water pressure while said drum is being filled with said water is increased by way of said pressure-reducing device up to a maximum pressure of a connecting line to said water inlet.

21. The method as claimed in claim 17, wherein, when said pump is empty and prior to starting operation of said pump, water is admitted into said pump or into said pump chamber thereof at a water pressure being above said water pressure for a washing process.

22. The method as claimed in claim 21, wherein, for this purpose, said water pressure of at least 5 bar is set by way of said pressure-reducing device, wherein to said end said water pressure in said water routing system or of said water admitted into said washing machine at said water inlet into said washing machine is not reduced or decreased by way of said pressure-reducing device.

23. The method as claimed in claim 21, wherein the following steps are provided:
within at most 5 sec of setting said water pressure, a valve at said water inlet is opened,
a valve between said filter and said container outlet is opened or is already open, and a valve between said filter and said pump is closed or is in a closed state,
said filter is vented into said drum-receiving container or through said container outlet,
said valve between said filter and said pump is then opened,
then, said pump is vented through said opened valves and said water lines into said drum or into said drum-receiving container and filled with water through said filter,
water is recirculated by said pump in a circuit through said pump without said water reaching said drum-receiving container or said drum, wherein said water is here heated by way of a heating means past which said water flows,
once a desired temperature has been reached by said water, said heated water is then introduced into said drum or into said drum-receiving container through said opened valves and said water lines.

24. The method as claimed in claim 23, wherein said valve at said water inlet is opened simultaneously with setting said water pressure.

25. The method as claimed in claim 17, wherein, for emptying said washing machine, a valve between said container outlet and said filter is closed, wherein fresh water is introduced into said drum via a water line and a valve in order to rinse said drum, wherein a valve downstream of said pump is then closed, such that one of said water lines from said valve to a further valve, which further valve is arranged between said filter and said pump, is open and is rinsed, wherein, once said water line has been rinsed, said valve downstream of said pump is set such that said water can be pumped by said pump via one of said water lines and a further valve to said water outlet out of said washing machine.
